(19) United States
(12) Patent Application Publication
(10) Pub. No.: US 2008/0084327 A1
(43) Pub. Date: Apr. 10, 2008

(54) Multicolor illumination system

(76) Inventor: John Rubis, Lititz, PA (US)

Correspondence Address: BARLEY SNYDER, LLC, 1000 WESTLAKES DRIVE, SUITE 275, BERWYN, PA, 19312, US

(21) Appl. No.: 11/257,544

(22) Filed: Oct. 25, 2005

(51) Int. Cl. G09F 9/33; G08B 5/22

(52) U.S. Cl. 340/815.45

(57) ABSTRACT

An illumination system according to the invention includes a controller with a plurality of actuatable switches and a light board having multiple colored light emitting diodes (LEDs) which the user can control with the switches. A microcontroller is operatively connected to the switches. The microcontroller generates a modulated control signal in response to actuation of the switches. A high side driver is connected to and responsive to the modulated control signal to generate a light drive signal and the colored LEDs are selectively driven by the light drive signal.

### FIELD OF THE INVENTION

The present invention is related to illumination systems and more particularly to an illumination apparatus having the capability of illuminating an instrument in multiple colors.

### BACKGROUND

In the current state-of-the-art, illumination systems exist for illuminating instruments. These instruments are typically backlit with an incandescent or light emitting diode (LED) source. Such light sources have been developed for illuminating the instruments in a variety of colors. Typically, a light source of a desired color is installed into the instrument or a colored lens is utilized for achieving illumination in the desired color. Systems have also been developed in which a consumer may select between a plurality of colors using a single compound controllable light source. Such light selectable systems have been developed for new lines of instruments so that a consumer desiring a controllable selectable light source may purchase new instruments having this feature. These systems provide the consumer with the desirable feature of light color selectivity by providing a number of illumination colors, which the consumer may select. These systems however, are limited to a preset number of colors that the consumer may select between. Also, consumers are required to purchase new instruments having these features in order to achieve color selectability in illumination. It is desirable to give the consumer greater flexibility by providing a greater number of colors for illumination and it is also desirable to allow a retrofit color selectable illumination system for existing instruments eliminating the need to replace the instruments in order to achieve color selectability.

### SUMMARY OF THE INVENTION

In view of the need in the state-of-the-art, the invention provides an illumination system which includes a controller with a plurality of actuatable switches and a light board having multiple colored light emitting diodes (LEDs) which the user can control with the switches. A microcontroller is operatively connected to the switches. The microcontroller generates a modulated control signal in response to actuation of the switches. A high side driver is connected to and responsive to the modulated control signal to generate a light drive signal and the colored LEDs are selectively driven by the light drive signal.

### BRIEF DESCRIPTION OF THE DRAWINGS

The invention will now be described by way of example with reference to the accompanying figures of which:

FIG. 1 is a block diagram of a multicolor illumination system according to the present invention;

FIG. 2 is a diagram of a controller and light assembly according to the present invention;

FIG. 3 is a schematic of a light board utilized in the system of FIG. 1;

FIG. 4 is a schematic of a controller utilized in the system of FIG. 1;

FIG. 5 is a partial timing chart showing bit timing encoding utilized in the system of FIG. 1; and,

FIG. 6 is a diagrammatic view of a data frame utilized in the system of FIG. 1.

### DETAILED DESCRIPTION OF THE INVENTION

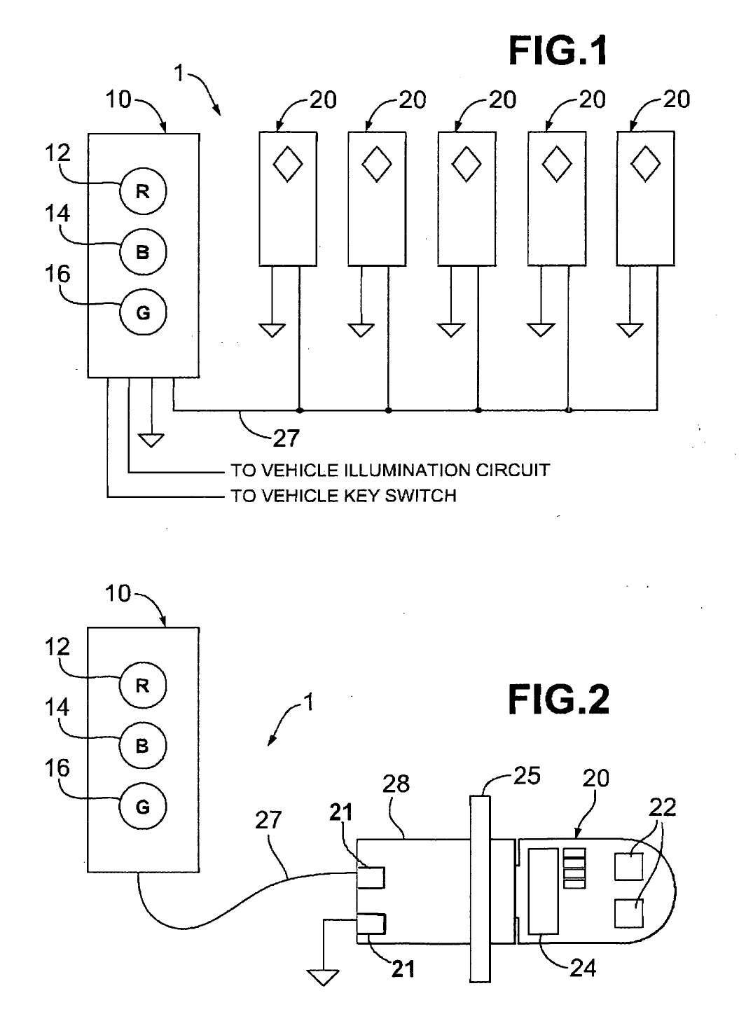

Referring first in FIGS. 1 and 2, the major components of the multicolor illumination system 1 will now be described. The multicolor illumination system 1 includes a controller 10, at least one light board 20, and a light board socket 28. A conductor 27 connects the controller 10 to the light board socket 28. A plurality of control buttons is included on the controller 10. A red control button 12, a blue control button 14 and an green control button 16 allow a user to control the light board 20 to achieve multicolor illumination as will be described below. It should be understood by those reasonably skilled in the art that while the controller 10 is shown here with three buttons, other types of control switches such as momentary or toggle switches may be utilized to achieve these functions. Similarly, while red, blue and green control buttons are shown here, it should be understood by those reasonably skilled in the art that other control schemes having different buttons such as a color up, a color down or a dimmer button, may be utilized to offer the user control over the light board 20.

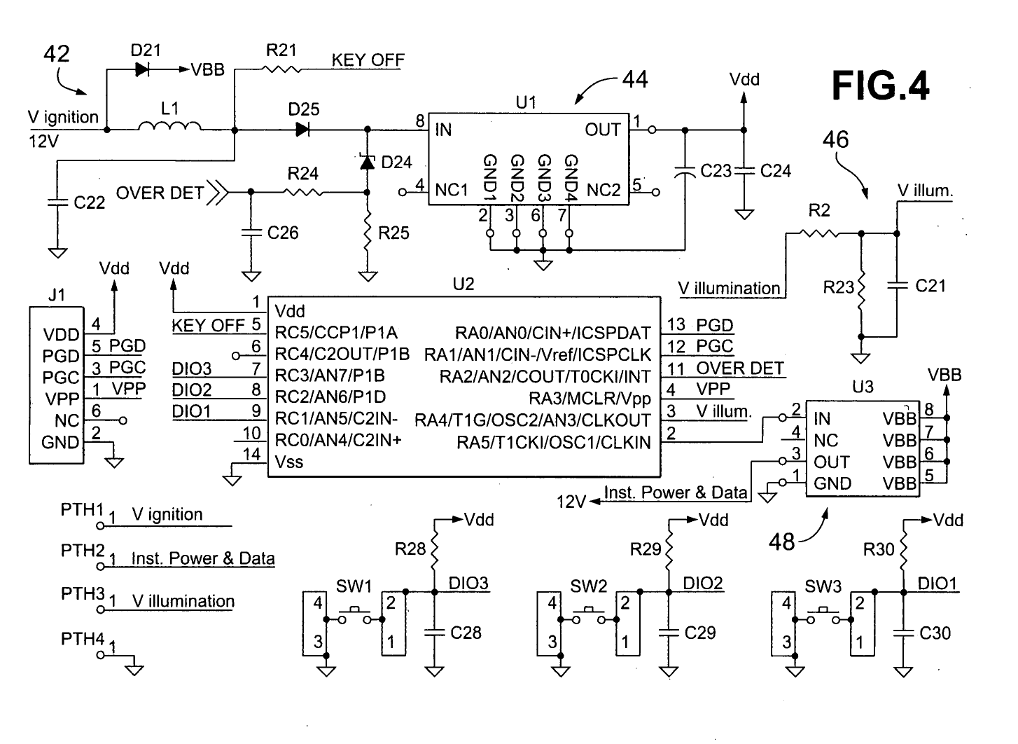

The conductor 27 connects the controller 10 to the light board socket 28 and ultimately to the light board 20. The light board socket 20 is configured to fit into an opening of an instrument which receives a standard incandescent or LED light socket, therefore making the light board 20 socket 28 a direct replacement retrofit part which may be utilized to illuminate an existing instrument. A plurality of mounting lugs 25 is provided on the light board socket 28. It should be understood by those reasonably skilled in the art that the mounting lug arrangement and light board socket configuration may be varied to achieve a direct replacement for other socket styles. It should also be understood that the multicolor illumination system 1 is not limited to use with a socket but could be alternatively implemented without the socket utilizing any other suitable electrical interface between the controller 10 and the light board 20. The light board 20 contains the illumination circuit 30 and the controller 10 houses the control circuit 40 shown in FIG. 4, which will be described below, in greater detail.

The light board 20 being formed of a printed circuit board or other suitable substrate is mounted and electrically connected to the light board socket 28. The major components mounted on the light board 20 include a microcontroller 24 and a plurality of multicolor light emitting diodes (LEDs) 22 being surface mounted thereon. A pair of contacts 21 are optionally positioned on the light board 20 to supply an electrical connection to an existing light socket which was designed for a standard incandescent bulb. This configuration advantageously allows the light board 20 to be a direct replacement for an incandescent bulb. It should be understood by those reasonably skilled in the art that while these major components are shown here as being surface mounted on to the light board 20 they can be mounted or otherwise integrated using well-known techniques. It should also be understood that other electrical interfaces are anticipated which would allow the light board 20 to fit in other socket arrangements.

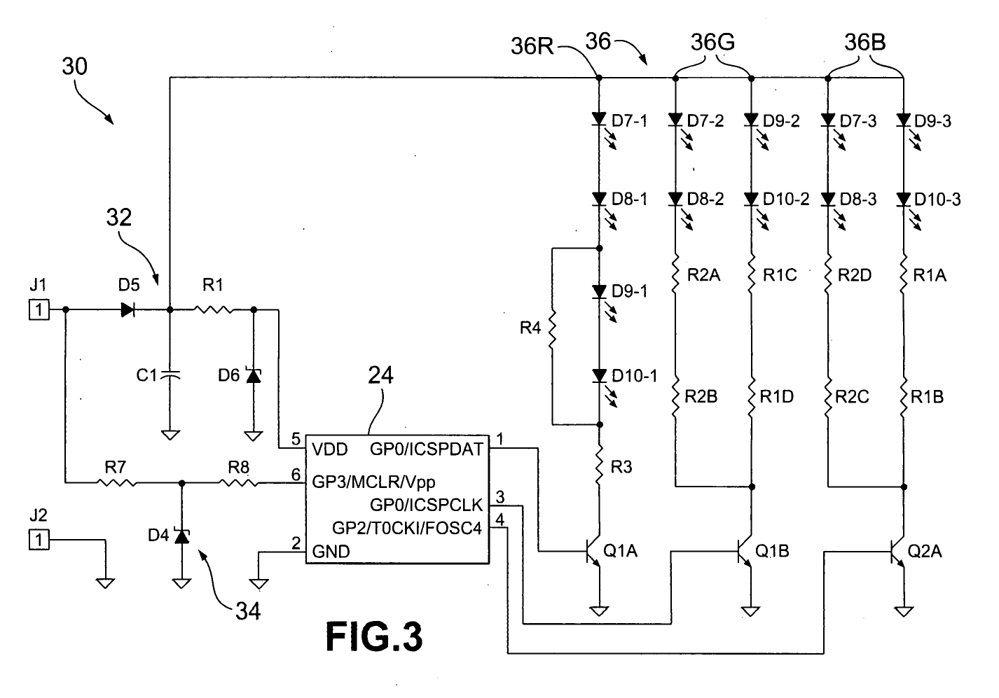

An exemplary embodiment of the illumination circuit 30 which includes the major components 24, 22 mounted on the light board 20 will now be described in greater detail with reference to FIG. 3. Major sections of the illumination circuit 30 include an input section 32, a regulator section 34, a microcontroller 24, and a light section 36. The input section 32 receives the output of the microcontroller U2 from pin 2 and includes a diode D5 connected in series with a resistor R1. A capacitor C1 is connected between the diode D5 and ground and a zener diode D6 is connected between the resistor R1 and ground. The resistor R1 is connected to the VDD input of the microcontroller 24 at pin 5. The regulator section 34 also receives the output of the controller 10 at J1 and consists of resistors R7 and R8 connected in series with a zener diode D4 which is connected between the resistors R7, R8 and ground. The regulator section 34 is connected to a Vpp input of the microcontroller 24 at pin 6. In the light section 36, a plurality of red LEDs D7-1, D8-1, D9-1, and D10-1 are connected in the red light section 36R between the rectified output of the input section 32 and ground through resistors R3, R4 and an active switch transistor Q1A. Similarly, a plurality of green LEDs D7-2, D8-2, D9-2, and D10-2 are connected in the green light section 36G between the rectified output of the input section 32 and ground through resistors R2A, R2B, R1C, R1D and an active switch transistor Q1B. Similarly, a plurality of blue LEDs D7-3, D8-3, D9-3, and D10-3 are connected in the blue light section 36B between the rectified output of the input section 32 and ground through resistors R2D, R2C, R1A, R1B and an active switch transistor Q2A. Each of the switch transistors Q1A, Q1B, and Q2A is controlled by respective outputs from pins 1, 3 and 4 of the microcontroller 24. It should be understood by those reasonably skilled in the art that while each light section 36 is shown with a plurality of LEDs in this embodiment, other numbers of LEDs connected either in series or in parallel may be utilized to achieve the desired light output intensity level for each color.

An exemplary control circuit 40 will now be described in greater detail with reference to FIG. 3. Major sections of the control circuit 40 include an input filter 42, a power supply 44, an illumination voltage section 46, a microcontroller U2, a high side driver 48, and the plurality of control switches SW1-3. The input filter 42 includes a 12 V input from the vehicle's ignition system fed through diode D21 to a 12V output VBB which drives the high side driver 48 as will be described below. The filter includes an inductor L1 connected in series with a diode D25 for supplying input (pin 8) to a linear supply U1 of the power supply 44. Capacitor C22 is connected to ground at a junction between the inductor L1 and the diode D25. Overvoltage detection is provided through resistor R24, capacitor C26, resistor R25 and zener diode D24. The power supply 44 receives the 12 V input at pin 8 and outputs a voltage, Vdd at pin 1 of approximately 5 V. The illumination voltage section 46 receives a voltage from the vehicle which is controlled through a dimmer and passes that voltage through a series parallel circuit of R22, R23 and C21 into pin 3 of the microcontroller U2. The high side driver 48 receives a control output in the form of a pulse width modulated signal from pin 2 of the microcontroller U2 which is fed into pin 2 of an integrated circuit U3. The high side driver 48 is supplied with the voltage VBB of approximate 12 V. A 12 V pulse width modulated light drive signal is output from the high side driver 48 at pin 3 of the integrated circuit used 3 and fed through PTH2 to J1 of the illumination circuit 30. The control output of the microcontroller U2 at pin 2 is controlled by a user depressing one or more of the control switches SW1-3 on the controller 10. Switch SW1 is actuated by the red control button 12. Switch SW2 is actuated by the blue control button 14. Switch SW3 is actuated by the green control button 16. In an alternate embodiment, SW1 is actuated by color up button, SW2 is actuated by a color down button and SW3 is actuated by a dimmer button. In this alternate embodiment a user may sweep through the color spectrum by depressing the color up (SW1) or color down (SW2) buttons and then adjust the light intensity of the selected color by depressing the dimmer button (SW3). These control switches SW1-3 shown schematically in FIG. 3 supply momentary power to inputs DIO1, DIO2 and DIO3 of the microcontroller U2 when depressed. In response to these inputs, the microcontroller U2 is programmed to alter the pulse width modulated signal output at pin 2 as will be described in greater detail below.

Operation of the multicolor illumination system 1 will now be described in greater detail. The system 1 receives power from the vehicle's ignition systems through the input filter 42 of the control circuit 40. An illumination voltage section 46 provides a voltage signal from a dimmer circuit of the vehicle which is indicative of desired light output. The microcontroller U2 receives these power and control inputs along with control inputs from control switches SW1-3 which allow the user to control the amount of red, blue and green light output desired. The user is able to change or sweep through colors by depressing one or more of the red, blue or green buttons 12, 14, 16 on the controller 10. In the alternate embodiment, the user may select colors by depressing the color up/color down buttons and then selecting intensity by depressing the dimmer button. In either case, the microcontroller U2 generates a control signal output at pin 2, which in this embodiment is a pulse width modulated signal having a series of data frames. The data frames are generated by the microcontroller U2 in response to actuation of the control switches SW1-3.

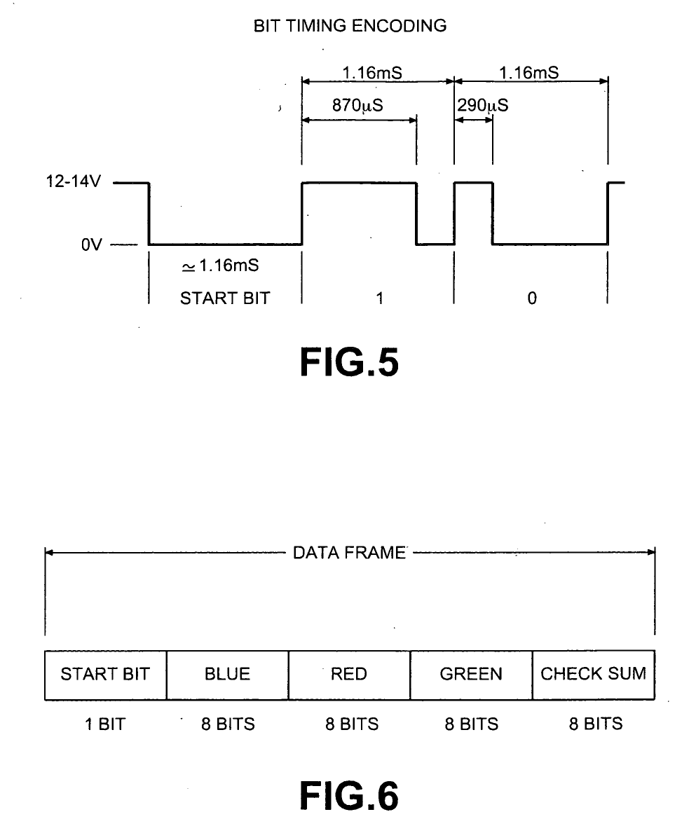

An exemplary data frame is shown in FIG. 6. Each data frame begins with a start bit followed by an 8-bit blue code, then an 8-bit red code, then an 8-bit green code, and finally an 8-bit checksum code. In this exemplary embodiment, the data frame of FIG. 6 is encoded with a pulse width modulated signal, a portion of which is shown in FIG. 5. It should be understood by those reasonably skilled in the art that while the data frame is shown here as being encoded by a pulse width modulated signal, other modulation techniques are possible and within the scope of the invention. Referring to FIG. 4, the start bit is an approximately 1.16 ms low signal followed by the first two bits of a blue code wherein a digital 1 is represented by an 870 μs high signal followed by a 290 μs low signal and a digital 0 is represented by a 290 μs high signal followed by an 870 μs low signal. It should be understood by those recently skilled in the art that the timing of this pulse width modulated signal is merely exemplary and other timings schemes maybe used to achieve digital control. The 8-bit codes allow 256 levels for each of the blue, red and green colors. Depressing the dimmer button (SW3) in the alternate embodiment, through the microcontroller U2, applies a multiplier to each 8-bit code therefore limiting the number of levels to some number less than 256 when the dimmer is depressed. This multiplier effectively limits the duty cycle of each code therefore driving the LEDs at a lower level.

The control output signal including these data frames is then passed through the high side driver 48, boosting the pulse width modulated signal from 0-5V to 0-12V, for driving the illumination circuit 30. In the illumination circuit 30, the boosted pulse width modulated light drive signal drives the active switch transistors Q1A, Q1B, Q2A illuminating the LEDs in the light section 36 at the desired blue, red and green levels. In this way, a user may sweep through varying shades of red, blue, green and combinations thereof by depressing the control buttons 12, 14, 16 and then stop at the desired shade upon release of the control buttons 12, 14, 16. The pulse width modulated signal which drives the light section 36 remains unchanged in the absence of any control switch SW1-3 actuation keeping the light output color constant until the user depresses one of the control buttons 12, 14, 16. Alternatively, microcontroller U2 can be programmed such than upon receipt of a certain control input from the control switches SW1-3, for example, simultaneously actuating SW1 and SW2, it goes into a sweep mode wherein the continuously sweeps through colors by continuously altering the pulse width modulated control signal to the light section 36.

Advantageously, the system 1 allows the user to sweep through varying shades of each color using the buttons on the controller 10 until a desired color is displayed. The number of possible colors is therefore greatly increased over the currently available products. The socket and light board assembly may also be designed to be a replacement or retrofit part to replace a single color incandescent bulb on an instrument.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An illumination system comprising:
a controller having a plurality of actuatable switches;
a microcontroller being operatively connected to the switches; the microcontroller generating a modulated control signal in response to actuation of the switches;
a high side driver being connected to and responsive to the modulated control signal to generate a light drive signal; and
a light board having multiple colored light emitting diodes (LEDs) and switches being selectively driven by the light drive signal.

2. The illumination system of claim 1 wherein the plurality of switches include a red, blue and green switch.

3. The illumination system of claim 1 wherein the plurality of switches include an up, down, and dimmer switch

4. The illumination system of claim 1 wherein the control signal comprises a data frame having red, blue and green codes.

5. The illumination system of claim 4 wherein the codes are digital codes and the control signal is a pulse width modulated signal.

6. The illumination system of claim 5 wherein the codes are generated in response to momentary actuation of the switches alters the data frame through the microcontroller to sweep colors of light emitted by the LEDs.

7. The illumination system of claim 6 wherein the light board has a second microcontroller which decodes the light drive signal to control corresponding switches supplying power the LEDs.

8. The illumination system of claim 1 further comprising an illumination input signal being controlled by a dimmer and being input to the microcontroller.

9. The illumination system of claim 1 further comprising a light board socket receiving the light board and being an electrical interface between the controller and the light board.

10. The illumination system of claim 9 wherein the light board socket has a mounting lug being disposed to be a direct replacement for an incandescent bulb socket.

11. An illumination system comprising:
a controller having a plurality of actuatable switches;
a microcontroller being operatively connected to the switches; the microcontroller generating a modulated control signal in response to actuation of the switches;
a high side driver being connected to and responsive to the modulated control signal to generate a light drive signal; and
a light board having multiple colored light emitting diodes (LEDs) and switches being selectively driven by the light drive signal; the light board being configured to have contacts thereon for electrically connecting the light board to a light socket designed for an incandescent bulb.

12. The illumination system of claim 11 wherein the plurality of switches include a red, blue and green switch.

13. The illumination system of claim 11 wherein the plurality of switches include an up, down, and dimmer switch.

14. The illumination system of claim 11 wherein the control signal comprises a data frame having red, blue and green codes.

15. The illumination system of claim 14 wherein the codes are digital codes and the control signal is a pulse width modulated signal.

16. The illumination system of claim 15 wherein the codes are generated in response to momentary actuation of the switches alters the data frame through the microcontroller to sweep colors of light emitted by the LEDs.

17. The illumination system of claim 16 wherein the light board has a second microcontroller which decodes the light drive signal to control corresponding switches supplying power the LEDs.

18. The illumination system of claim 11 further comprising an illumination input signal being controlled by a dimmer and being input to the microcontroller.

19. The illumination system of claim 11 further comprising a light board socket receiving the light board and being an electrical interface between the controller and the light board.
